(19) United States
(12) Patent Application Publication
(10) Pub. No.: US 2016/0157673 A1
(43) Pub. Date: Jun. 9, 2016

(54) SPIKE-ON-RAILS STYLE TOASTING DEVICE

(71) Applicant: Hula Dog Franchise, Inc., Honolulu, HI (US)

(72) Inventors: Lawrence Paille, Kapaa, HI (US); Dominique Quinette, Honolulu, HI (US); Scott March, Kailua-Kona, HI (US)

(21) Appl. No.: 14/924,334

(22) Filed: Oct. 27, 2015

Related U.S. Application Data
(60) Provisional application No. 62/124,204, filed on Dec. 9, 2014.

(51) Int. Cl. A47J 37/04

(52) U.S. Cl. CPC A47J 37/049

(57) ABSTRACT

A toasting device includes a housing, a plurality of heating spikes extending outwardly from an upper surface of the housing, and a controller electrically coupled to the internal heating elements of the plurality of heating spikes, the controller configured to control electrical power to the plurality of heating spikes to thereby control temperature. At least one of the plurality of heating spikes includes a thermocouple coupled to the controller for measuring temperature. An upper surface of the housing includes a plurality of rail attachment holes for connecting rail portions to the housing.

### CROSS-REFERENCE TO RELATED APPLICATIONS

The present application claims the benefit of Provisional Application No. 62/124,204 filed on Dec. 9, 2014.

### TECHNICAL FIELD

The technical field relates generally to devices for cooking food items and, more particularly, to a spike-style toasting device for such cooking.

### BACKGROUND

A conventional spike-style toasting device includes heating spikes disposed on a housing, wherein each of the heating spikes includes a heating element. In operation, a food item such as, for example, bread for a hot dog or sausage, is placed on a heating spike to form a cavity in the food item. Heat generated from the heating element in the heating spike heats the heating spike, which thereby toasts the interior of the food item.

Examples of toasting devices include the “Sandwich Tool” described in U.S. Pat. No. 1,848,030 to Sibley, the “Bun Puncher and Toaster” described in U.S. Pat. No. 1,902,564 to Mabey, the “Bun Toaster” described in U.S. Pat. No. 2,648,275 to Thompson, the “Device for Toasting the Interior of Buns” described in U.S. Pat. No. 3,377,943 to Frank, the “Heating Apparatus for Bread and Filler Material” described in U.S. Pat. No. 3,635,146 to Jean-Pierre, the “Internal Bun Toaster” described in U.S. Pat. No. 3,965,808 to Chomette, and the “Bread Impaling Cooking Utensil” described in U.S. Pat. No. 7,339,136 to Schmanski, among others, the contents all of which are incorporated herein by reference.

### SUMMARY

Underwriters Laboratories (UL) is a safety consulting and certification company that provides safety-related certification, validation, testing, inspection, as well as other services to manufacturers, retailers, etc. NSF international is a global independent public health and environmental organization that provides product standards, product certification, as well as other services. UL and NSF standards are currently accepted in all fifty states. Moreover, some government agencies require that UL and/or NSF standards be satisfied for commercial cooking equipment. Therefore, it is preferably that a toasting device satisfies UL and/or NSF standards.

It is desirable that the temperature of the heating spikes of the toasting device be raised to a high temperature such as, for example, 475 degrees Fahrenheit in a short amount of time in order to shorten the time required to toast the food item. On the other hand, it is also desirable to stop or substantially limit heat transfer from the heating spikes to the housing of the toasting device because such heat transfer can shorten the operational life of the device components and presents an unsafe operating condition.

An approach to limiting heat transfer is to include ventilation holes in the base of the housing as described in U.S. Pat. No. 3,635,146 to Jean-Pierre. However, this approach is not acceptable under existing commercial sanitary standards because the holes can give vermin access to the interior of the device.

Another approach to limit heat transfer is to place the heating spikes on top of elevated rectangular boxes referred to here as “rail portions” which are fixed to a chassis of the housing. The rail portions include openings for dissipating heat before it is transferred to the housing. The bottom of the chassis also contains openings to vent heat. Placing the heating speaks on the rail portions can prevent damage to electrical components on the chassis from excessive heat. However, the rail portions can create inaccessible areas which are difficult to clean, thereby allowing build-up of crumbs and non-stick sprays from the spikes. Further, there can be an unacceptable gap where the rail portions attach to the chassis which also cannot be properly cleaned. Such a toasting device may not satisfy certain NSF standards and thereby not be accepted by UL.

In view of the above problems, as well as other concerns, a spikes-on-rails style toasting device for heating a plurality of food items according to the present disclosure includes a housing, a plurality of heating spikes, and rail portions. Base portions of the plurality of heating spikes can be connected to the rail portion. Rail portions can be connected to an upper surface of the housing via a plurality of rail portion attachment holes. Each of the heating spikes can be made of aluminum and includes an internal heating element and a pointed portion extending outwardly from the upper surface of the housing for creating a cavity in a respective one of the plurality of food items. The internal heating element can be disposed within an upper half of the respective heating spike to provide an unheated lower portion of the respective heating spike. The upper surface of the housing, the rail portions, and the plurality of heating spikes define a food zone which contacts the plurality of food items. The housing can include an aluminum bottom plate and a stainless steel chassis.

According to one aspect, the rail portion includes a plurality of tab portions which are folded towards an interior side to connect the rail portion to the upper surface of the housing. A sealant can be disposed in gaps between the upper surface of the housing and the rail portion between the tab portions.

According to another aspect, the rail portion includes a flange portion extending along an outer periphery of the rail portion. The flange portion is folded towards an interior side of the rail portion to eliminate gaps and is connected to the upper surface of the housing.

According to another aspect, the rail portion includes a plurality of ventilation holes. The rail portion can include an interior screen portion and/or louvers to prevent interior contamination via the ventilation holes. Alternatively, a screen portion including a plurality of openings through which the plurality of heating spikes can pass through can be disposed over the rail portion.

The toasting device can further include one or more thermal cutoff devices configured to shut off one or more internal heating elements when a temperature associated with one or more of the plurality of heating spikes is greater than a predetermined limit.

A controller electrically coupled to the plurality of heating spikes is configured to control electrical power to the plurality of heating spikes to thereby control temperature of the toasting device. At least one of the plurality of heating spikes includes a thermocouple electrically coupled to the controller for measuring the temperature.

According to another embodiment, the base portions of the heating spikes are fixed to the upper surface of the housing and the rail portions are eliminated. A plurality of cover portions are disposed on the upper surface to cover the rail insertion holes, each of the cover portions including two attachment members disposed in two of the plurality of rail insertions holes.

During operation, food items can be placed on the plurality of heating spikes of the toasting device to form the cavity having an opening at only one end in each of the food items. The controller is manipulated by the user prior to or after placing the food items to provide power and thereby heat to the heating spikes. The food items are heated to a predetermined temperature to thereby toast an interior surface of the cavities.

### BRIEF DESCRIPTION OF THE DRAWINGS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

FIG. 1 is a top perspective view of the toasting device according to an exemplary embodiment.

FIG. 2 is a front perspective view of the toasting device.

FIG. 3A is a top view of the toasting device.

FIG. 3B is a side view of the toasting device.

FIG. 3C is a rear view of the toasting device.

FIG. 3D is a front view of the toasting device.

FIG. 4A is a cross-sectional view of a heating spike according to an exemplary embodiment.

FIG. 4B is a view of a base portion of the heating spike shown in FIG. 4A.

FIG. 5 is a diagram illustrating a layout of a chassis of the housing of the toasting device according to an exemplary embodiment.

FIG. 6A is a diagram illustrating a layout of an exemplary rail portion according to an exemplary embodiment.

FIGS. 6B-6C are diagrams illustrating exemplary rail portions according to exemplary embodiments.

FIG. 7 is a diagram illustrating a bottom plate of the housing according to an exemplary embodiment.

FIG. 8 is a diagram illustrating a bottom plate of the housing according to another exemplary embodiment.

FIG. 9A is a diagram illustrating a layout of an exemplary rail portion according to another exemplary embodiment.

FIG. 9B is a diagram illustrating a layout of an exemplary rail portion according to another exemplary embodiment.

FIG. 10A-10B are top perspective views of the toasting device in which a screen is placed over one of the rail portions according to an exemplary embodiment.

FIG. 11 is a perspective view of a cover portion according to an exemplary embodiment.

FIG. 12 is a perspective view of a portion of the toasting device according to another embodiment in which the cover portion covers the rail connection holes.

FIG. 13 is a top perspective view of a toasting device showing a gap at the rail/chassis interface.

FIG. 14 is a partial side perspective view showing a gap at the rail/chassis interface.

FIG. 15 is a block diagram illustrating an electrical circuit of the toasting device.

### DETAILED DESCRIPTION

In overview, the present disclosure concerns a toasting device for food items such as bread for a hot dog or sausage referred to as a “bun”. In the various embodiments discussed in the disclosure the term “bun” will be used here to refer to all types of bread. However, it should be noted that the toasting device is not limited to a bun, but can also be used to toast other food items. Further, toasting here can refer to, for example, browning, cooking, or generally heating the bun particularly or food item generally by exposure to heat.

The instant disclosure is provided to further explain in an enabling fashion the best modes of performing one or more embodiments of the toasting device. The use of relational terms such as first and second, top and bottom, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

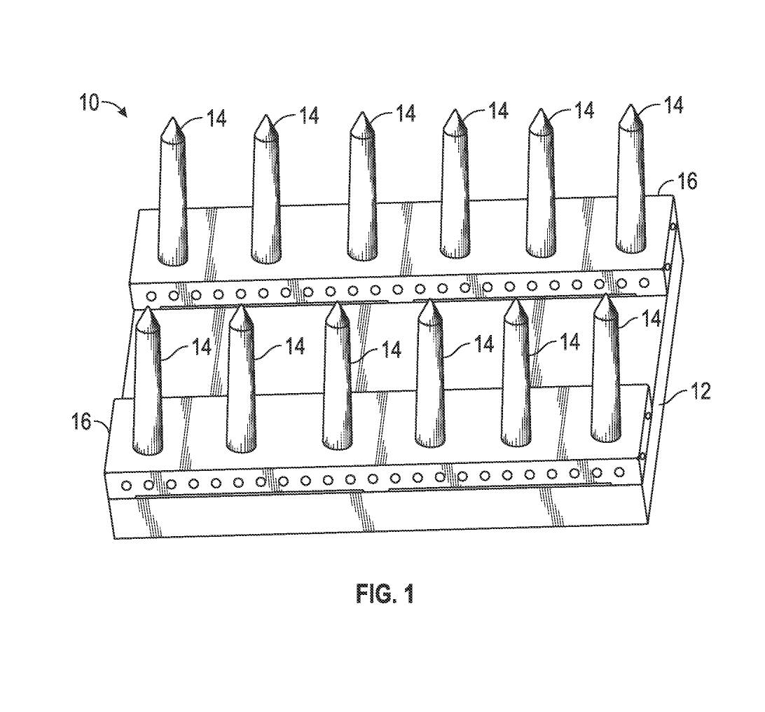

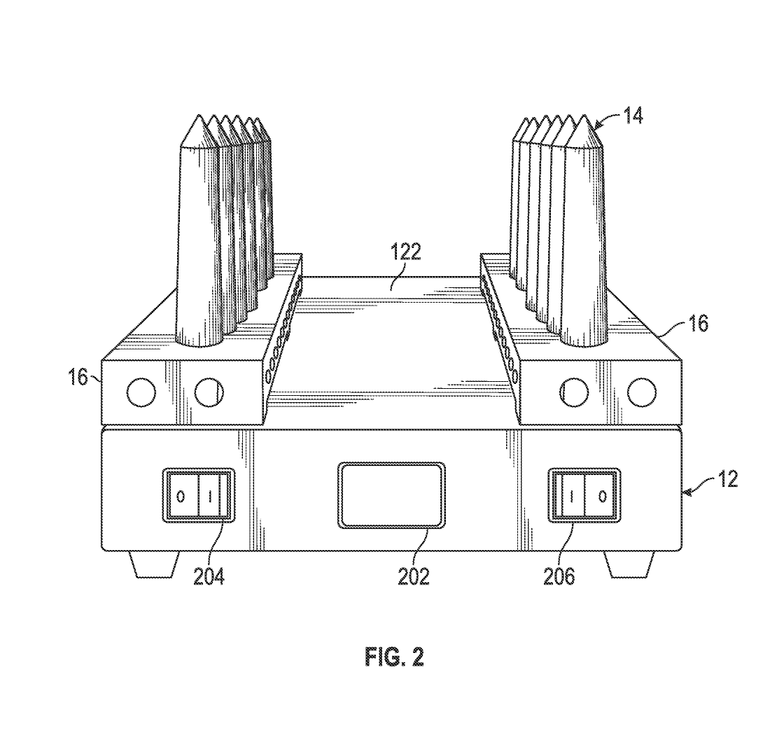

Referring to FIGS. 1-2, the toasting device 10 includes a housing 12, a plurality of heating spikes 14 and first and second rail portions 16. In this exemplary configuration, the toasting device 10 includes twelve heating spikes 14 arranged in two linear rows of six. However, the toasting device 10 is not limited to this arrangement. Particularly, other arrangements of the heating spikes 14 such as in a circle, square, grid or other geometrical figures are possible. The upper surface 122 of the housing 12, the rail portions 16, and the plurality of heating spikes 14 define a food zone which can contact food items to be toasted.

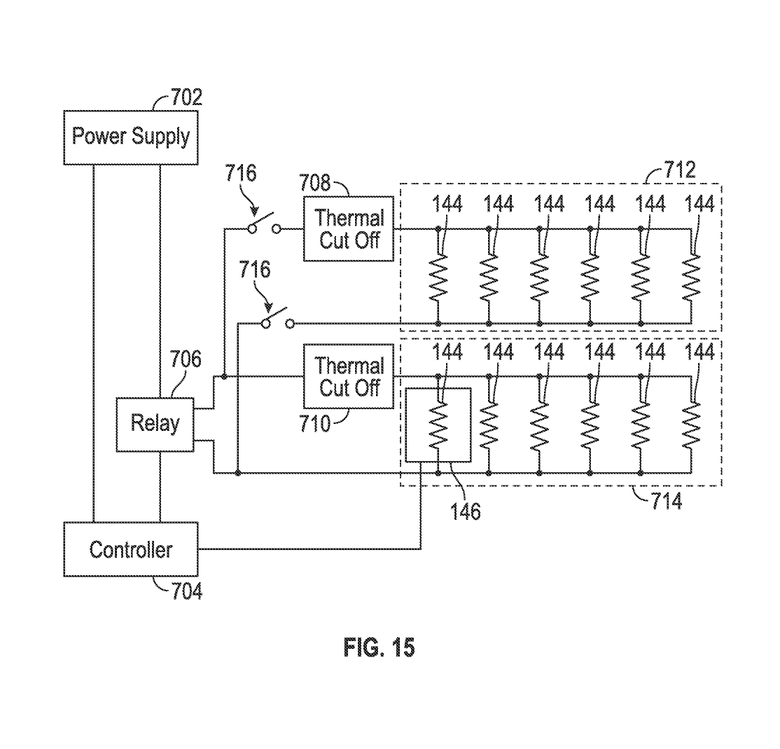

The housing 12 includes a digital temperature control panel 202 and first and second switches 204, 206 on one of the side plates 124. The first and second switches 204, 206 can switch power on and off to the first and second rows of the heat spikes 14, respectively. The panel 202 can be the user interface for a digital controller (see FIG. 15) which is electrically coupled to the plurality of heating spikes 14 by, for example oven-grade wiring. Particularly, the control panel 202 can include a digital display for displaying a temperature associated with the toasting device 10 and buttons for adjusting the temperature. The digital controller can obtain the temperature to be displayed from a thermocouple included in one of the heating spikes 14. The digital controller can control the temperature of one or more of the spikes 14 by sending a control signal to adjust the electrical power (current or voltage) to the respective heating spikes.

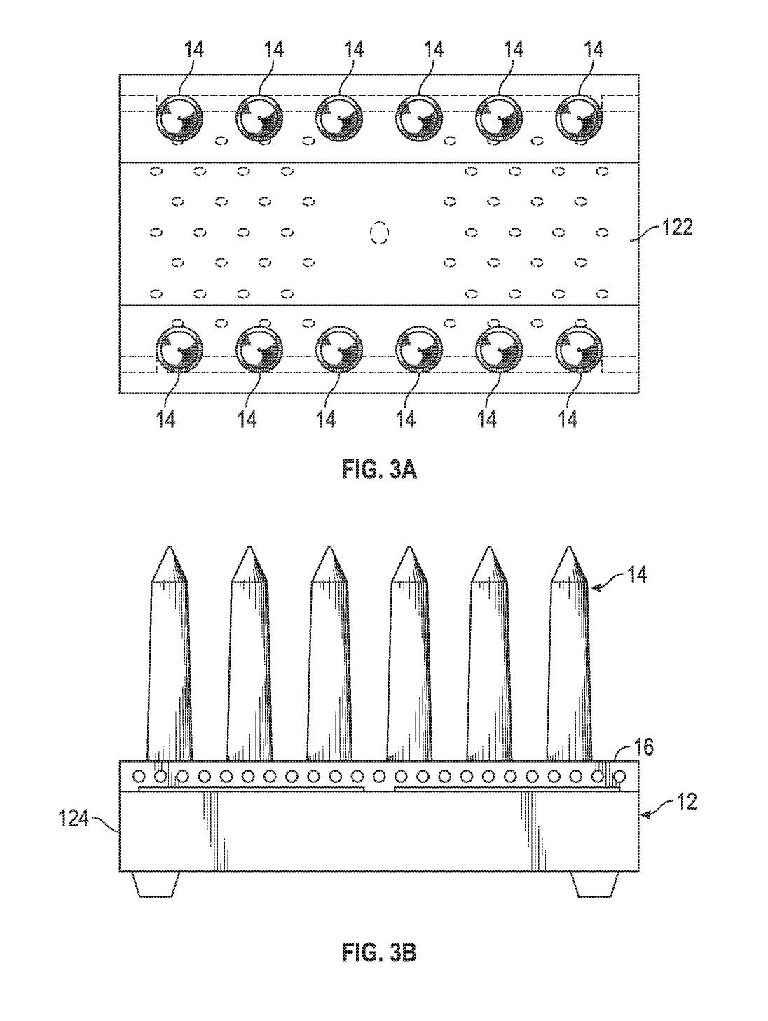

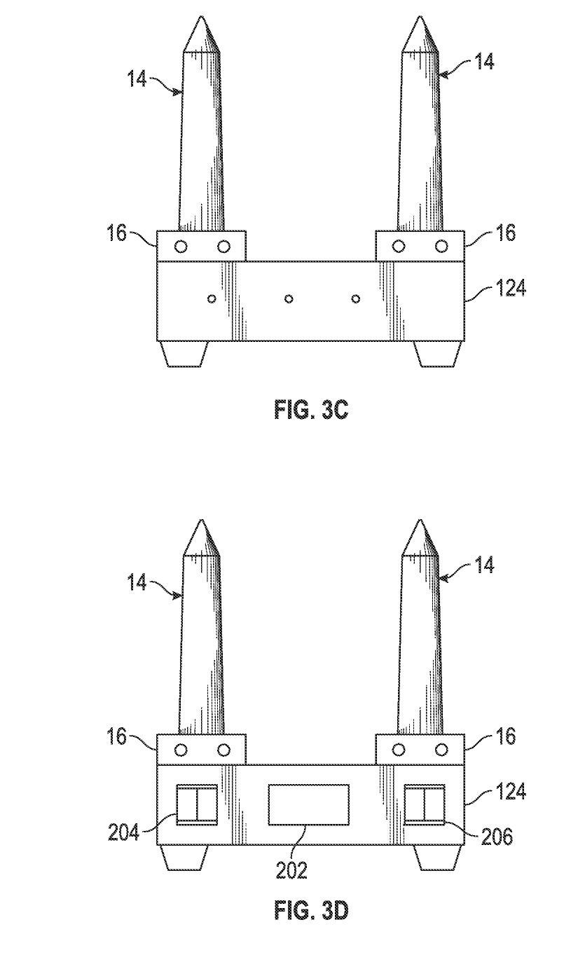

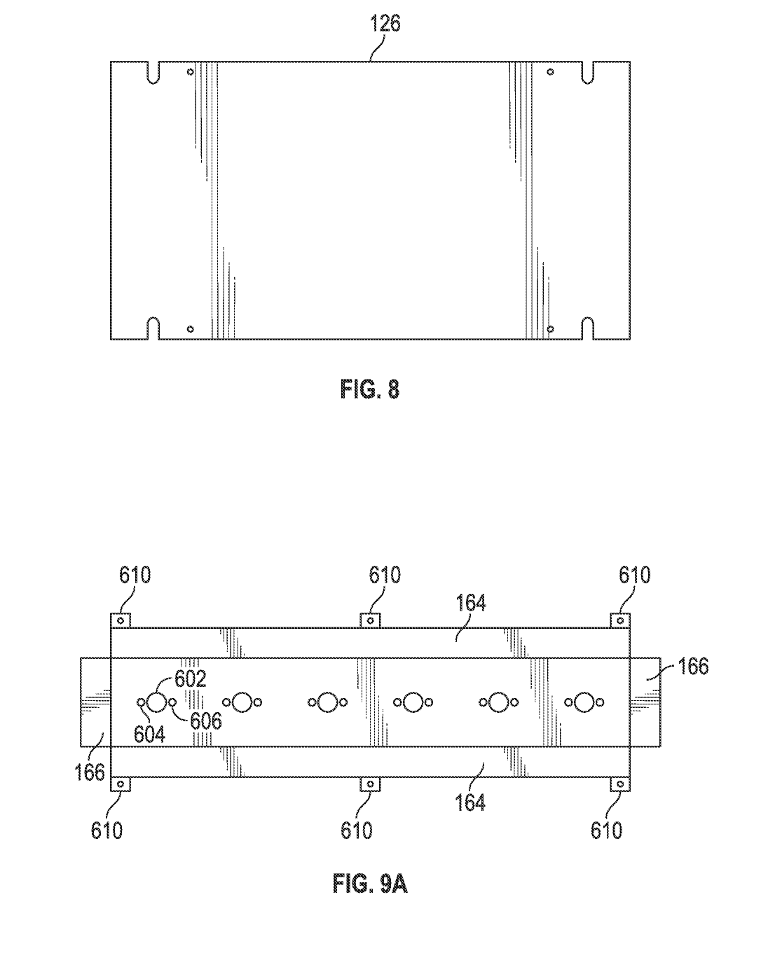

Referring to FIGS. 3A-3D, the housing 12 can include an upper plate 122, four side plates 124 and a bottom plate 126 (See FIGS. 7-8). The upper and side plates 122, 124 can be a metal chassis composed of any commercially certified metal such as, for example, #16 stainless steel 4B T-304. The upper plate 122 can have a width of approximately 11 inches and a length of 24 inches. The side plates 122, 124 can have a height of approximately 2.6875 inches. The bottom plate 126 can be, for example, a 0.063 inch thick aluminum 3003 plate. Generally, the upper plate 122 of the housing 12 is preferably made of food-grade metal.

As shown in FIG. 7, the bottom plate 126 can include ventilation holes 702 for preventing the toasting device 10 from overheating. However, the ventilation holes 702 can allow vermin to have access to the interior of the toaster device 10 where crumbs can collect. The ventilation holes 702 can also present a fire danger, as safety standards require that a small electrical fire be contained within the device 10 and that burning debris not reach surfaces of the toasting device 10. Accordingly, the housing 12 can include an interior screen portion covering the ventilation holes 702 in the bottom plate. The interior screen portion can be 16 mesh (minimum of 16 strands per inch) or greater. Moreover, the internal electrical components can be moved away from the ventilation holes 702. Alternatively, as shown in FIG. 8, the bottom plate 126 can be impermeable (no ventilation holes) to prevent contamination of an interior of the housing.

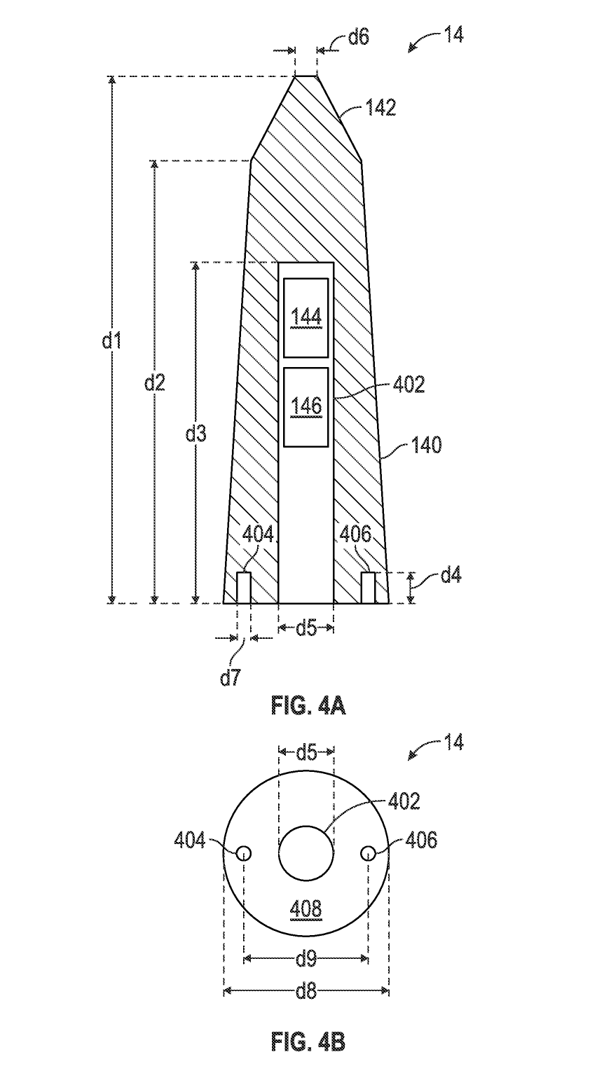

Referring to FIGS. 4A-4B, the plurality of heating spikes 14 will be discussed. Each of the heating spikes 14 extends outwardly from the upper surface on the upper plate 122 of the housing 12 and includes a tapered portion 140 and a pointed portion 142. When a bun is placed on the pointed portion 142, the pointed portion 142 can create a cavity in the bun. Generally, a height d1 of the spikes 14 is not limited, but can be decided based upon the typical food item to be toasted. In one exemplary configuration, the height d1 of each of the spikes 14 is 6 inches and a height d2 of the tapered portions 140 of the spikes 14 is 5 inches. Further, a width d6 of a top of the pointed portion 142 may be, for example, 0.125 inches. A base portion 408 of the spike 14 can be circular shaped with a diameter d8 of, for example, 1.25 inches.

Each of the heating spikes 14 includes an internal chamber 402 for storing an internal heating element 144. At least one of the heating spikes 14 further includes a thermocouple 146 in the chamber 402 for temperature measuring. Although not shown here, an oven-grade wire extending in the chamber 402 connects the heating element 144 and the thermocouple 146 to the electrical portion in housing 12. The chamber 402 can have a diameter or width d5 of, for example, 0.375 inches. Generally, the shape and height of the internal chamber 402 are not limited. However, the chamber 402 should preferably have a height d3 sufficient for positioning the internal heating element 144 far enough away from the housing 12 to prevent or substantially limit heat transfer from the heating spike 14 to the housing 12. Particularly, a height d3 of the internal chamber 402 can be greater than 50 percent of the height d2 of the tapered portion and/or 40 percent of the height d1 of the spike 14. For example, in one exemplary configuration, the height d3 of the internal chamber is 2.625 inches. More preferably, the internal heating chamber 402 can have a height d3 sufficient for positioning the internal heating element 144 in an upper half of the heating spike 14 and more near the pointed portion 142 so that an unheated lower portion below the internal hearing element remains cool. This unheated lower portion will be referred to here as a cold zone. The cold zone will be between the heated portion of the heating spike 14 and the housing 10. For example, in one exemplary configuration, the height d3 of the internal chamber is 4.125 inches.

A base portion 408 of the heating spike 14 includes two receiving portions 404, 406 for receiving engaging portions of attachment members to connect the heating spike 14 to the rail portion 16. Generally, the height d4 and width d7 of the receiving portions 404, 406 are not limited. However, in one exemplary configuration, the receiving portions 404, 406 are holes configured with 10-32 interior threads. A distance d9 between centers of the receiving portions can be, for example, 0.9375 inches.

Each of the heating spikes 14 can be made from a food-grade metal such as, for example, aluminum. Particularly, an aluminum rod can be machined on its outer surface to form the tapered and pointed portions 140, 142. The chamber 402 and receiving portions 404, 406 can be formed by drilling the aluminum rod.

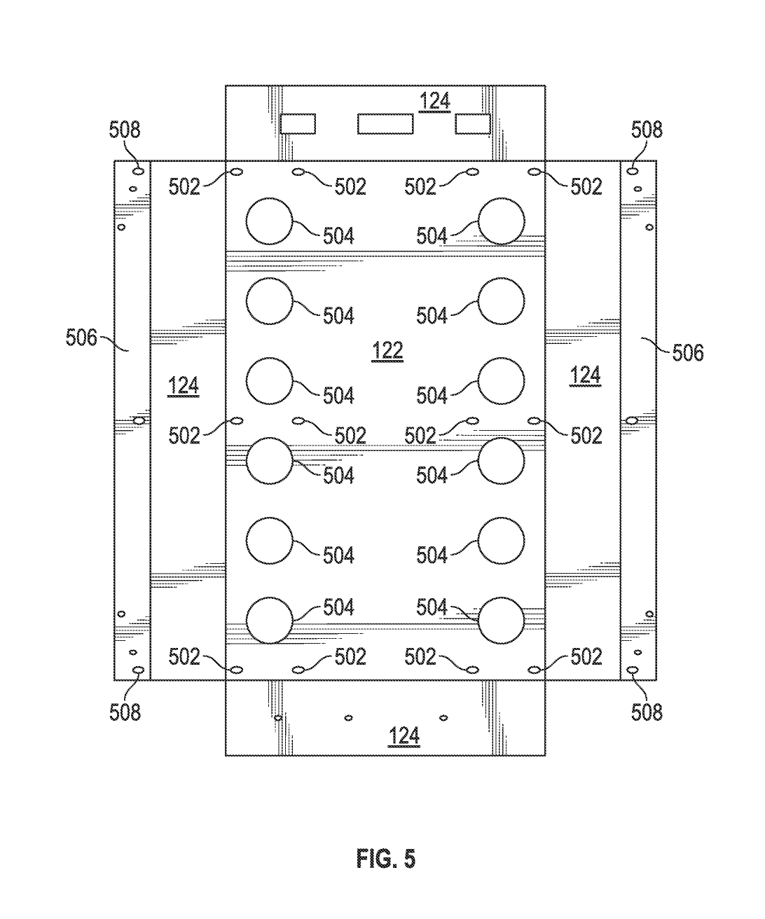

A layout for the chassis of the housing 12 is shown in FIG. 5. The upper plate 122 includes a plurality of through-holes 504 for allowing the oven-grade wire from electrical portions in the housing 12 to pass to the heating element 144 and the thermocouple 146 in the heating spikes 14. The upper plate 122 also includes a plurality of rail portion attachment holes 502 for connecting first and second rail portions 16 to the housing 12. The two lateral (longer) length side plates 124 include flange portions 506 which are folded towards the interior of the housing 12 and include through-holes 508 for attachment members such as screws to connect the chassis to the bottom plate 126 via corresponding through-holes 704 on the bottom plate 126.

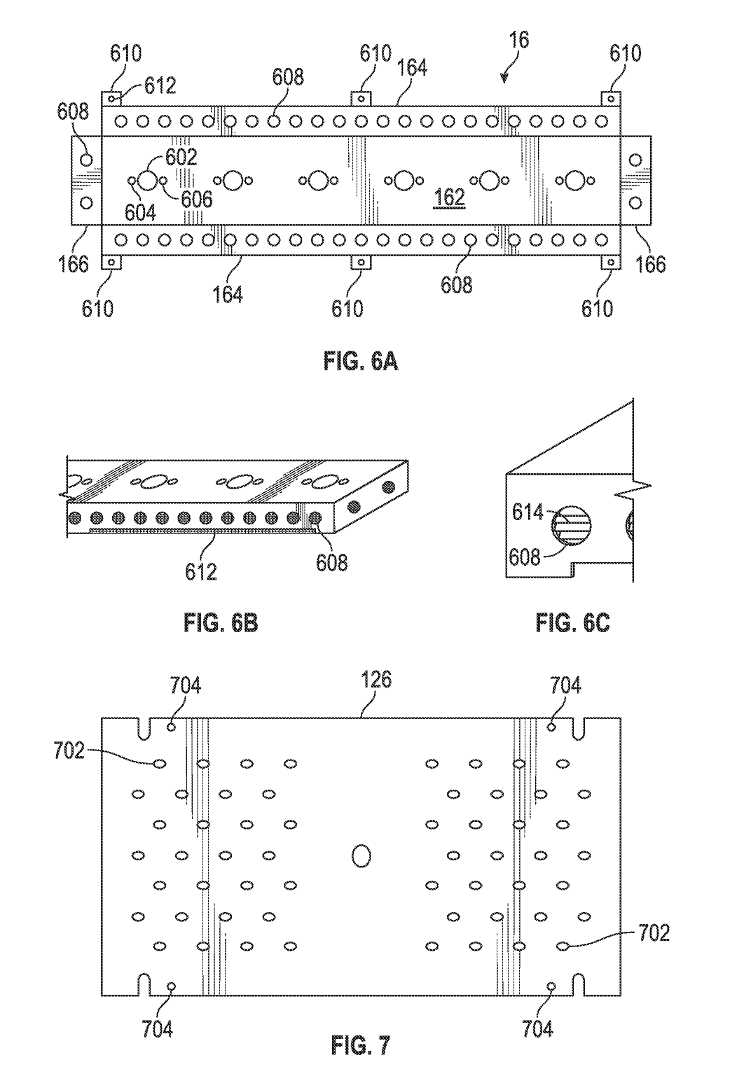

A layout for the rail portions 16 according to an embodiment is shown in FIG. 6A. The rail portion 16 includes a top portion 162, longitudinal (longer) side portions 164, and lateral (shorter) side portions 166. The longitudinal side portions 164 include a plurality of tab portions 610 which are folded towards an interior direction. Each of the tab portions 610 includes a through-hole 612 for attachment members such as screws to connect the rail portion 16 to the upper surface 122 of the housing 12 via rail portion attachment holes 502. The tab portions 610, in effect, lift the rail portion 16 slightly above the chassis and create gaps 1302 (see FIG. 14) between the rail portions 16 and the upper surface 122 of the housing 12 between the the tab portions 610. A sealant can be disposed in the gaps 1302.

Returning to FIG. 6A, the longitudinal side portions 164 and lateral side portions 166 include a plurality of ventilation holes 608. The top portion 162 of the rail portion 16 includes a center through-hole 602 and a plurality of through-holes 604, 606. The through-holes 604, 606 can include a clearance for receiving attachment members to connect the rail portion 16 to the base portion 408 of the heating spikes 14. The center through-hole 602 provides a passage for feeding a wire connecting the heating element 144 and/or thermocouple 146 to the electrical portion in the housing 12. The center through-hole 602 can have a diameter of, for example, 0.375 inches. Similar to the housing 12, the rail portions 16 can be composed of a food-grade aluminum or stainless steel. The ventilation holes 608 can dissipate heat before it reaches the chassis. However, these openings may be unacceptable pursuant to NSF 4 standards because the ventilation holes 608 create inaccessible areas and make proper cleaning difficult. Accordingly, as shown in FIG. 6B, the rail portion 16 can include an interior screen portion 612 to cover the ventilation holes 608 and prevent interior contamination. The screen (16 mesh or greater) is affixed to the inside of the rail portion sides and ends to prevent contamination via the ventilation holes 608 and the gaps at the rail/chassis interface. The rail portions 16 and the interior screen portion 612 can be removable for cleaning. Alternatively, as shown in FIG. 6C, each of the plurality of ventilation holes 608 can include a louver 614 to prevent interior contamination.

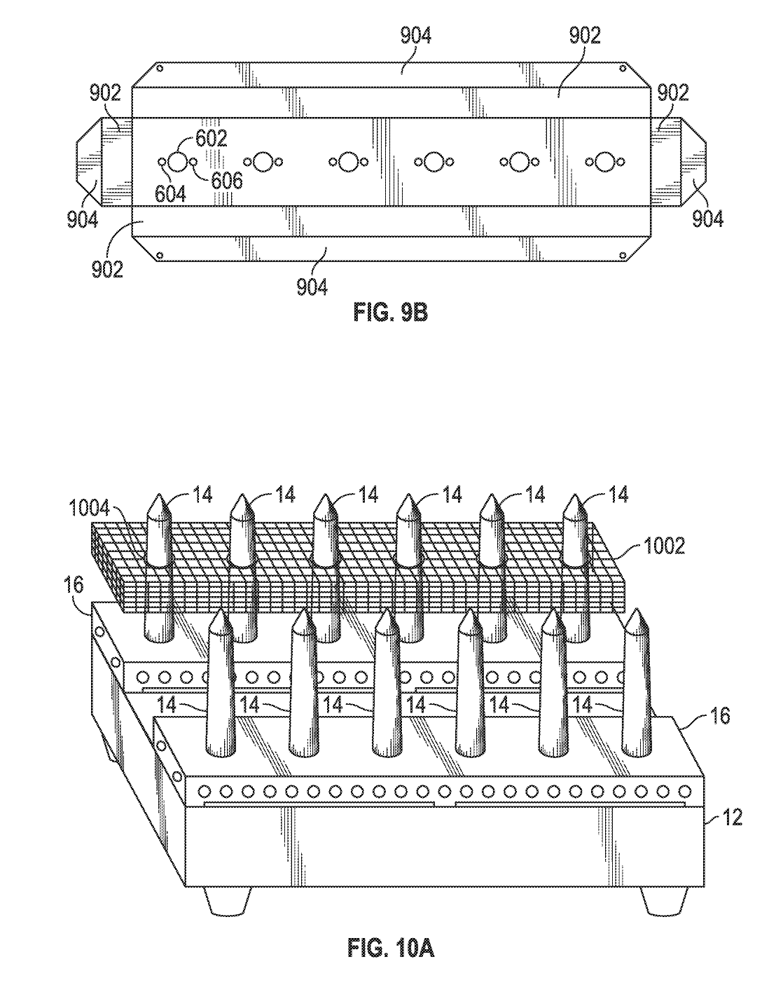

A layout for the rail portions according to another embodiment is shown in FIG. 9A. The rail portion 16 is similar to that of FIG. 6A, except the outer surfaces 164, 166 are impermeable (no ventilation holes 608) to prevent interior contamination. The holes 602, 604, 606 are covered with the heating spikes 14. All remaining holes in the rail portion 16 contain screws.

A layout for the rail portions according to another embodiment is shown in FIG. 9B. The rail portion 910 is similar to that of FIG. 9A, except a flange portion 904 extends along an outer periphery of the rail portion rather than the tab portions 610. The flange portion 904 includes through-holes for connecting to the upper surface of the housing similar to the tab portions. The flange portion 904 is folded towards an interior side of the rail portion 910. All four sides of the rail portions 16 rest completely on the flange portions 904 to eliminate any gaps 1302 shown in FIG. 14. The ends of the flange portions 904 can be cut at a forty-five degree angle to avoid corner interference to accomplish a full seal between the rail portions 16 and the upper surface 122 at an entire periphery of the rail portions 16.

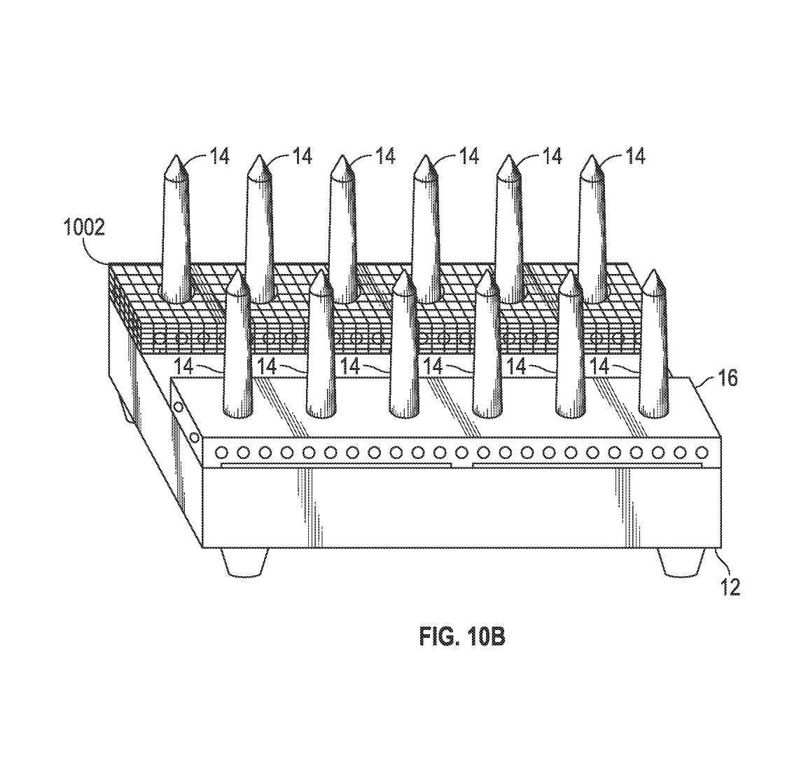

Referring to FIGS. 10A-10B, the toasting device 10 can include box-shaped screen portions 1002 for resting on the rail portions 16 to prevent interior contamination via the ventilation holes 608. The screen portion 1002 includes a plurality of openings 1004 through which the plurality of heating spikes 14 pass through, respectively. As shown in FIG. 10B, the dimensions of the screen portions 1002 can be set so that the screen portion 1002 can rest flush on the rail portions 16 and on the upper surface 122 of the housing 12 to cover the ventilation holes 608 thus permitting ventilation, while preventing crumbs and vermin from entering the rail portions 16. The screen portion 1002 is removable for cleaning. The screen portion 1002 is preferably 16 mesh or greater and made of food-grade material such as aluminum or stainless steel.

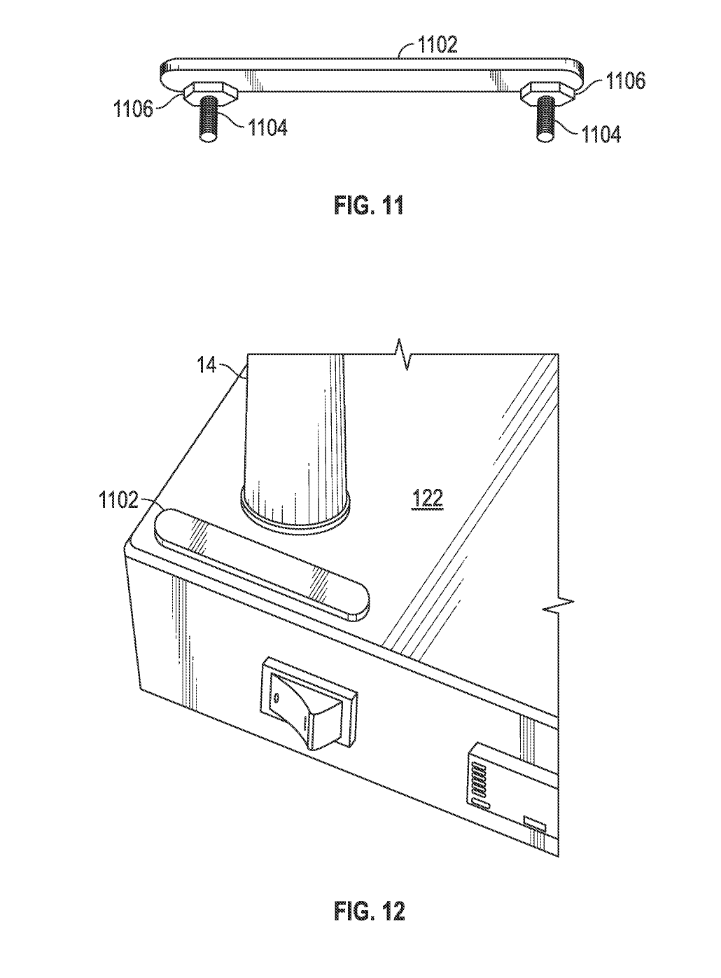

Referring to FIGS. 11-12, in another embodiment of the toasting device 10, the base portions 408 of the plurality of heating spikes 14 are fixed directly to the upper surface 122 of the housing 12 without the rail portions. Cover portions 1102 are disposed on the upper surface 122 to cover the rail insertion holes 502. Each of the cover portions 1102 includes two attachment members 1104 disposed in two of the plurality of rail insertions holes 502. Each of the cover portions 1102 can be a metal bar, and the two attachment members 1104 can be two embedded screws with accompanying nuts 1106. The two embedded screws 1104 are adopted to fit in the two of the plurality of rail insertion holes 502, and the nuts tightened on the two embedded screws 1104 on an opposite side of the upper surface 122 so that the cover portion 1102 is flush on the upper surface 122.

As shown in FIG. 1, the heating spikes 14 are arranged in first and second linear rows. The plurality of cover portions 1102 include a first middle cover portion disposed between two of the heating spikes 14 in the first linear row, a first front cover portion disposed in front of the first linear row, and a first rear cover portion disposed in rear of the first linear row, a second middle cover portion disposed between two of the heating spikes in the second linear row, a second front cover portion disposed in front of the second linear row, and a second rear cover portion disposed in rear of the second linear TOW.

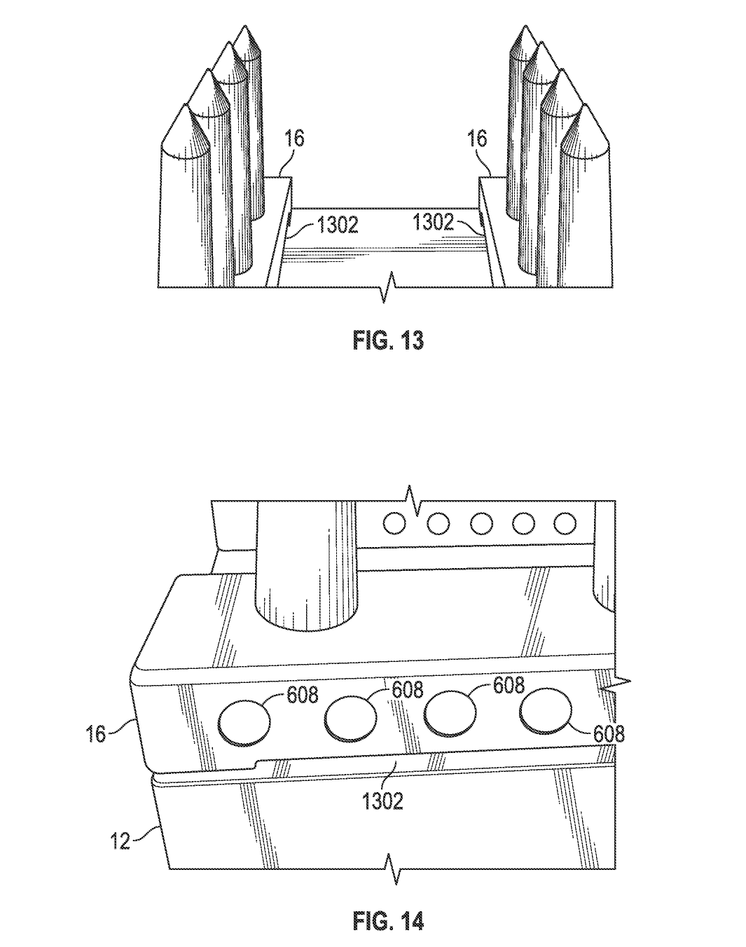

Referring to FIGS. 13-14, the toasting device 10 can include gaps or uneven surfaces (depicted generally by 1302) at the interface between upper surface 122 and a lower portion of the rail portion 16. Food material can accumulate in and around the attachment members and along the edge of the rail portions 16. The gaps 1302 can be a violation of commercial sanitary standards such as NSF 4. As discussed above, the gaps 1302 can be sealed with a food grade, heat tolerant sealant which complies with such standards as NSF 4 and NSF 51.

Referring to FIG. 15, an exemplary electrical circuit configuration of the toasting device 10 will be discussed. A power supply 702 provides electrical power to the controller 704 directly and to the heating elements 144 of the spikes via a relay 706. Grounding can be provided by an internal grounding connection (not shown). The heating elements 144 of each of the first row 712 and second row 714 are connected together in parallel row-wise. The heating elements 144 of the first row 712 can be connected to the relay 706 via switch 716. Switch 716 can be a double pole, single throw (DPST) switch which represents the right switch 206 on the front panel. Another switch (not shown) connected to the power on and off to the controller 704 can represent the left switch 204. One of the spikes in the second row 714 includes the thermocouple 146. The controller 704 can be directly coupled to the thermocouple 146 to measure the temperature of its spike, thereby measuring the temperature of the toasting device 10. The controller 704 is coupled to the heating elements 144 via the relay 706.

Optionally, first and second thermal cutoff devices 708 and 710 can be coupled to the first row 712 and second row 714 of the heating elements 144, respectively. Potential overheating of the heating spikes and other electrical malfunctions present safety issues when using the toasting device, particularly in heavy-duty commercial use. The thermal cutoff devices 708, 710 can stop power supply and thus shut-off the internal heating elements 144 of its respective row when, for example, a temperature associated with the heating spike is greater than a predetermined limit and/or when a malfunction occurs.

During operation, food items (not shown) are placed on the plurality of heating spikes 14 of the toasting device 10 to form a cavity having an opening at only one end in each of the plurality of food items. Particularly, the switches 204, 206 are switched on to permit electrical power to flow to the rows 712, 714 of heating elements 144 from the power supply 702 via relay 706. The controller 704 is manipulated by the user via adjustment interfaces on the digital temperature control panel 202 prior to or after placing the food items on the spikes 10 to adjust the electrical power to the heating elements 144 and thus the heat of the heating spikes 14. The food items are heated to a predetermined temperature to thereby toast an interior surface of the cavities.

The power supply 702 may supply 220 VAC through a strain relieved cord terminated in a 20 AMP 250 VAC plug. The relay 706 may be an OMRON G7L-2A-TUBJ-C3 Relay. The switches 716 can be CA series non-illuminated rocker switches made by C&K Components. The internal heating elements 144 may be 150 or 200 Watt cartridge heaters. The thermal cutoff devices 708, 710 can be a normally closed Testco Series 36T21 configured to open and cut off power at approximately 248 degrees Fahrenheit (±9) or 120 degrees Celsius (±5).

The controller 704 can be a digital controller such as, for example, a Fuji micro-controller PXR series digital temperature controller. Generally, the digital controller can be a controller executing computer instructions (software) stored in memory, integrated circuits (ICs), and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, discussion of such software and ICs is limited.

Other embodiments will be apparent to those skilled in the art from consideration of the specification and practice of the invention disclosed herein. It is intended that the specification and examples be considered as exemplary only, with a true scope and spirit of the invention being indicated by the following claims.

1. A toasting device for heating a plurality of food items, the toasting device comprising:
a housing;
a plurality of heating spikes, each including a pointed portion extending outwardly in a direction opposite from an upper surface of the housing for creating a cavity in a respective one of the plurality of food items, a base portion, and an internal heating element; and
a controller electrically coupled to the internal heating elements of the plurality of heating spikes, the controller configured to control electrical power to the plurality of internal heating elements to thereby control temperature,
wherein at least one of the plurality of heating spikes includes a thermocouple for measuring temperature, the thermocouple electrically coupled to the controller, and
wherein the upper surface of the housing includes a plurality of rail portion attachment holes for connecting a rail portion to the housing.

2. The toasting device of claim 1, wherein a bottom plate of the housing is impermeable to prevent contamination of an interior of the housing.

3. The toasting device of claim 1, wherein:
a bottom plate of the housing includes a plurality of ventilation holes; and
the housing includes an interior screen portion covering the ventilation holes in the bottom plate.

4. The toasting device of claim 1, further comprising a rail portion connected to the upper surface of the housing via the rail attachment holes, wherein the base portion of each of the plurality of heating spikes is fixed to the rail portion.

5. The toasting device of claim 4, wherein outer surfaces of the rail portion are impermeable to prevent interior contamination.

6. The toasting device of claim 4, wherein the rail portion includes a plurality of ventilation holes and an interior screen portion to prevent interior contamination via the ventilation holes.

7. The toasting device of claim 4, wherein the rail portion includes a plurality of ventilation holes, and each of the plurality of ventilation holes includes a louver to prevent contamination of the interior of the rail portion via the ventilation holes.

8. The toasting device of claim 4, further comprising a screen portion disposed over the rail portion, the screen portion including a plurality of openings through which the plurality of heating spikes pass through, respectively.

9. The toasting device of claim 4, wherein:
the rail portion includes a plurality of tab portions which are folded towards an interior side, the tab portions connecting the rail portion to the upper surface of the housing; and
a sealant is disposed in gaps between the upper surface of the housing and the rail portion between the tab portions.

10. The toasting device of claim 4, wherein the rail portion includes a flange portion extending along an outer periphery of the rail portion, the flange portion folded towards an interior side of the rail portion and connected to the upper surface of the housing.

11. The toasting device of claim 1, further comprising a thermal cutoff device configured to shut off the internal heating elements when a temperature associated with the plurality of heating spikes is greater than a predetermined limit.

12. The toasting device of claim 1, wherein the internal heating element in each of the plurality of heating spikes is a 150 or 200 watt cartridge heater.

13. The toasting device of claim 1, wherein:
the housing includes an aluminum bottom plate, and a stainless steel chassis; and
each of the plurality of the heating spikes is composed of aluminum.

14. The toasting device of claim 1, wherein:
the base portions of the plurality of heating spikes are fixed to the upper surface of the housing; and
a plurality of cover portions are disposed on the upper surface to cover the rail insertion holes, each of the cover portions including two attachment members disposed in two of the plurality of rail insertions holes.

15. The toasting device of claim 14, wherein each of the cover portions is a metal bar, and the two attachment members are two embedded screws with accompanying nuts, the two embedded screws adopted to fit in the two of the plurality of rail insertion holes, and the nuts tightened on the two embedded screws on an opposite side of the upper surface so that the cover portion is flush on the upper surface.

16. The toasting device of claim 14, wherein the plurality of heating spikes are arranged in first and second linear rows, the plurality of cover portions include a first middle cover portion disposed between two of the heating spikes in the first linear row, a first front cover portion disposed in front of the first linear row, and a first rear cover portion disposed in rear of the first linear row, a second middle cover portion disposed between two of the heating spikes in the second linear row, a second front cover portion disposed in front of the second linear row, and a second rear cover portion disposed in rear of the second linear row.

17. A toasting device for heating a plurality of food items, the toasting device comprising:
a housing;
a rail portion connected to an upper surface of the housing;
a plurality of heating spikes, each including a pointed portion extending outwardly in a direction opposite from an upper surface of the housing for creating a cavity in a respective one of the plurality of food items, a base portion connected to the rail portion, and an internal heating element;
a controller electrically coupled to the internal heating elements of the plurality of heating spikes, the controller configured to control electrical power to the plurality of heating spikes to thereby control temperature; and
a screen portion disposed over the rail portion, the screen portion including a plurality of openings through which the plurality of heating spikes pass through, respectively,
wherein at least one of the plurality of heating spikes includes a thermocouple for measuring temperature, the thermocouple electrically coupled to the controller.

18. The toasting device of claim 17, wherein:
the rail portion includes a plurality of tab portions which are folded towards an interior side, the tab portions connecting the rail portion to the upper surface of the housing; and
a sealant is disposed in gaps between the upper surface of the housing and the rail portion between the tab portions.

19. The toasting device of claim 17, wherein the rail portion includes a flange portion extending along an outer periphery of the rail portion, the flange portion connected to the upper surface of the housing, and the flange portion is folded towards an interior side of the rail portion.

20. The toasting device of claim 17, wherein:
a bottom plate of the housing includes a plurality of ventilation holes; and
the housing includes an interior screen portion covering the ventilation holes in the bottom plate.
